(19) United States
(12) Patent Application Publication
(10) Pub. No.: US 2006/0229739 A1
(43) Pub. Date: Oct. 12, 2006

(54) Device control method and device control system

(75) Inventor: Koji Morikawa, Kyoto (JP)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/448,341

(22) Filed: Jun. 7, 2006

Related U.S. Application Data
(63) Continuation of application No. PCT/JP05/03020, filed on Feb. 24, 2005.

(30) Foreign Application Priority Data
Feb. 27, 2004 (JP) 2004-054155

(51) Int. Cl. G05B 11/01

(52) U.S. Cl. 700/19; 700/20

(57) ABSTRACT

A storage section stores various sensor signals obtained in an input section together with operation contents instructed in an output section. A signal discrimination section references the storage section to specify a sensor of which output value is influenced by a given operation. An operation result prediction section and an operation determination section generates through learning a prediction model expressing a relationship between the operation and the specified sensor and determines, with the generated prediction model referenced, an operation that allows an output of a target sensor to be a target value.

### CROSS REFERENCE TO RELATED APPLICATIONS

This is a continuation of Application PCT/JP2005/003020 filed on Feb. 24, 2005. This Non-provisional application claims priority under 35 U.S.C. § 119(a) on Patent Application No. 2004-054155 filed in Japan on Feb. 27, 2004, the entire contents of which are hereby incorporated by reference.

### BACKGROUND ART

1. Field of the Invention

The present invention relates to a technology of autonomous device control in a system having at least one device and a plurality of sensors, such as a home use robot, an information terminal, a home use device network in an intelligent house, and the like, and particularly relates to a technology of performing determination of device's operation through prediction.

2. Description of the Prior Art

Recently, development in home use robots, information terminals, home use devices, and the like is progressing to have a multifunction. In these devices, numerous sensors for obtaining various input signals are incorporated for realizing various functions. Upon receipt of given input signals, the devices perform predetermined processing and determine outputs.

Of the devices, some devices have a learning function of adjusting an output in response to an input for adapting to change in external environment. For example, there is a method in which an input/output relationship is reproduced through leaning and an output is performed in accordance with the reproduced input/output relationship upon receipt of a given input.

Another device is one having a function of output determination through prediction for presenting ability beyond reproduction of the input/output relationship. Such a device learns results in response to outputs, namely, learns what kind of output changes externals how and provides what kind of feedback as a result. General methods such as a neural network, reinforcement learning, and the like are employable in this learning.

Referring to conventional prediction techniques, for example, output values of a visual sensor and a rotation angle sensor are input and a change in output value of the visual sensor in the next step is predicted (see Japanese Patent Application Laid Open Publication No. 2002-059384A). In this technique, correspondence between robot's operation and the visual sensor is learned by predicting one-step preceding information of the visual sensor. A recurrent neural network is employed as a learning method thereof.

Another technique is that: state evaluation equipment is prepared for predicting a future evaluation signal, and to what degree of reward can be obtained under what condition is predicted (see Japanese Patent Application Laid Open Publication No. 2002-189502A). In this example, a method called reinforcement learning is employed for maximizing a reward signal as an evaluation signal from the outside, and an operation is determined on the basis of each magnitude of rewards expected from operations.

In a function of output determination through prediction, a prediction model (predictor) to be learned plays an important role for operation determination. In the conventional prediction techniques, a system designer designs in advance an input and an output for a prediction model first, and then, learning is performed under the input/output relationship. However, as kinds of input signals and output operations are increased, the number of combinations of an input and an output increases explosively. In association therewith, the number of input/output combinations of the prediction models increases also, thereby causing difficulty in learning.

This point will be described with reference to a home use device network in an intelligent house.

For dwelling houses, recently, demand on energy conservation increases in association with a rising tide of environment consciousness while comfortable indoor environment is demanded. For realizing comfortable indoor environment, various devices such as an air conditioner, a heater, a cooler, and the like are operated appropriately to maintain room temperature, humidity, and the like in moderation. However, operating many devices leads to an increase in energy consumption, resulting in no energy conservation. In other words, the comfortableness in living environment and the energy conservation fall in a generally-called trade-off relationship, and therefore, some adjustment is necessary for reconciling them.

In recent dwelling houses, various sensors and devices are connected with one another through a network, so that information interchange is becoming enabled among the devices. In such a situation, each device can recognize operation states of the other devices even though a dweller does not grasp each operation of the devices. This means possibility of realizing compatibility between the comfortableness and the energy conservation by cooperative operation of devices. Appliances and sensors relating to living environment such as temperature and humidity include, for example, air conditioners, sensors for detecting person's whereabouts, cookers, gas fan heaters, humidifiers, dehumidifiers, and the like.

In order to realize the compatibility between the comfortableness and the energy conservation, the operation of each device must be determined accurately in various situations. The various situations include operation states of devices, output values of sensors (current room temperature and humidity, presence or absence of a human in a room, and the like), outdoor temperature, homecoming time of a human, and the like. Considering them as a plurality of variables that change chronologically, an appropriate relationship must be found from an enormous number of variables changing momentarily and an appropriate control instruction must be generated for an appropriate device.

For example, many humidifiers have a function of turning ON when an output value of a humidity sensor incorporated therein becomes lower than a predetermined value and turning OFF when it becomes higher than the predetermined value. However, only such simple control of a humidifier encounters difficulty in realizing the compatibility between the comfortableness and the energy conservation. For example, a device other than the humidifier, for example, a gas fan heater increases humidity by water vapor generated in combustion at an ON operation thereof. It is extremely difficult to set in advance a control rule that takes into consideration such an influence brought besides an influence brought by the function that the device basically has.

In home use robots and information terminals, kinds of incorporated sensors and the number of functions that can provide are increasing as well. A designer describes an operation rule in advance conventionally, which involves an enormous amount of working. The learning methods become difficult to adapt due to an increase in scale of the system.

It is not guaranteed that a configuration of the devices and the sensors in the system is the same still in the future, and they would be changed occasionally. For example: a novel device which was not developed at the time of system construction may be additionally connected; some device may be taken way or replaced with a new product because of disorder; and so on, which would be caused frequently. Thus, it is extremely difficult for a system designer to set in advance input/output of a model as conventionally done.

### SUMMARY OF THE INVENTION

In view of the foregoing, the present invention has its object of controlling, in a system including a device and sensors, the device autonomously for determining device's operation appropriately even in the case where precondition of input/output relationships is difficult with a large number of sensors and even in the case where the configuration of the device is changed.

The present invention provides a method for controlling, in a system including at least one device and a plurality of sensors, the device, which includes: a first step of recording an operation of the device into a storage section together with a change in output value of each of the sensors at the operation; a second step of specifying a sensor of which output value is influenced by the operation from data recorded in the storage section; a third step of generating, through learning, a prediction model expressing a relationship between the operation and the sensor having relation to the operation, which is specified in the second step, from the data recorded in the storage section; a fourth step of receiving a target sensor that defines a target state and a target value for an output of the target sensor; and a fifth step of selecting a model including the target sensor from the prediction model generated in the third step and determining an operation that allows the output of the target sensor to be the target value on the basis of the selected model, wherein when a configuration of the device and the sensors in the system are changed, the first step and the second step are executed, and whether or not a new prediction model is necessary is judged from a processing result in the second step, and the new prediction model is generated through learning when the new model is judged necessary.

In the present invention, the operation of the device is recorded in the storage section together with changes in output values of the sensors at the operation, and a sensor of which output value is influenced by the operation is specified from the date recorded in the storage section. Then, a prediction model expressing the relationship between the operation and the specified sensor is generated through leaning. In operation determination, a prediction model including the target sensor is selected from the generated prediction model, and an operation that allows the output of the target sensor to be the target value is determined on the basis of the selected prediction model.

Of the plurality of sensors, outputs of sensors of which change in output value is no concern of the operation become noise for operation determination. Accordingly, an input having relation to device's operation serving as an output of the system, that is, a sensor output is specified from a past history while sensor inputs of no concern thereto are excluded in advance. This reduces the prediction models in size, enhances learning ease and increases accuracy of the models even in a large-scale system. Hence, a further appropriate operation can be determined.

In the present invention, relationships between devices' operations and sensor values, which have not been taken into consideration conventionally, can be detected and used as prediction models.

It is preferable to take a future change in output value of the target sensor into consideration in operation determination in the fifth step. This enables operation determination taking into consideration changes in environment or a situation which would occur regardless of the system.

According to the present invention, compact and accurate prediction models can be generated autonomously with no advance input specification needed, attaining further appropriate operation determination based on prediction even in a large-scale system having numerous inputs and outputs and even in a system of which element configuration is changed frequently.

### BRIEF DESCRIPTION OF THE DRAWINGS

FIG. 1 is a conceptual diagram of an intelligent house as one example to which the present invention is applied.

FIG. 2 is a block diagram showing an internal constitution of an agent in FIG. 1.

FIG. 3 is a block diagram showing an internal constitution of an operation result prediction section in FIG. 2

FIG. 4 is a flowchart showing an overall flow of a device control method according to embodiments of the present invention.

FIG. 5 is a flowchart showing one example of details of steps S1 and S2 in FIG. 4.

FIG. 6A is an example of a model description using a neural network, and FIG. 6B is an example of a model description employing an IF-THEN rule.

FIG. 7 presents lists schematically indicating data for learning the models in FIG. 6

FIG. 8 is a flowchart showing one example of details of a step S3 in FIG. 4.

FIG. 9 is a schematic graph indicating a target state that takes indoor comfortableness into consideration.

FIG. 10 is a flowchart showing one example of details of a step S5 in FIG. 4.

FIG. 11 is a flowchart showing an operation when a configuration of a device and sensors is changed.

FIG. 12 is a block diagram showing a constitution of an agent according Embodiment 2 of the present invention.

FIG. 13 is a list indicating devices, devices' operations, and sensors which are presupposed in simulation.

FIG. 14 is a diagram showing relationships between the devices' operations set in the simulation and sensor values.

FIG. 15 presents graphs showing chronological changes in the devices' operations set in the simulation and in some of the sensor values.

FIG. 16 is a list indicating correlations between the devices' operations and the sensor values which are obtained from data in FIG. 15.

### DESCRIPTION OF THE PREFERRED EMBODIMENTS

Embodiments of the present invention will be described below with reference to the accompanying drawings.

### Embodiment 1

Embodiment 1 of the present invention will be descried by referring to devices installed in an intelligent house as an example. Herein, the intelligent house means a dwelling house in a condition that devices in the house are connected with each other through a network so as to enable information interchange among the devices. Each device is capable of obtaining information from the other devices and capable of using such information in an operation of its own.

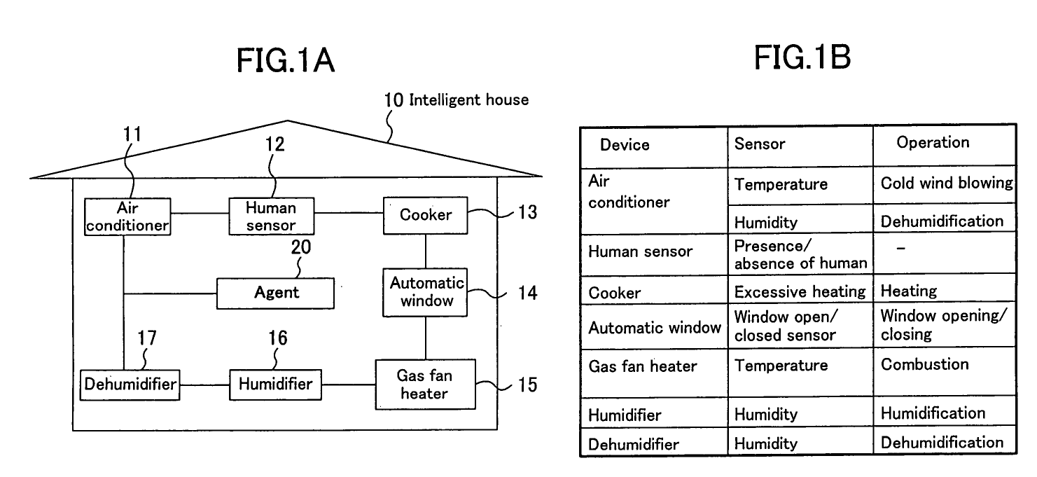

FIG. 1 is a conceptual diagram illustrating an example of the intelligent house. FIG. 1 indicates devices relating to control of living environment such as temperature and humidity in the house. In an actual intelligent house, various devices such as devices dealing with video or audio and devices relating to meals are installed besides the devices relating to the control of the living environment. However, only a partial configuration of the network in the intelligent house is shown in FIG. 1 conceptually for the sake of simple explanation.

In FIG. 1A, an intelligent house 10 includes an air conditioner 11, a human sensor 12 for detecting presence or absence of a human, a cooker 13 such as a hot plate, an automatic window 14 capable of controlling opening/closing from outside, a gas fan heater 15, a humidifier 16, and a dehumidifier 17. Further, an agent 20 is included as a device controller having no specific function but capable of collecting information from the devices 11 to 17 and issuing operation instructions to the devices 11 to 17.

FIG. 1B shows sensors that the respective devices 11 to 17 have and examples of executable operations thereof. Each device 11 to 17 incorporates only sensor(s) necessary for independently performing an operation of its own and includes an output tool (an actuator) for playing a role of its own. For example, the air conditioner 11 includes a temperature sensor and a humidity sensor and performs cold wind blowing or humidification as operations of its own.

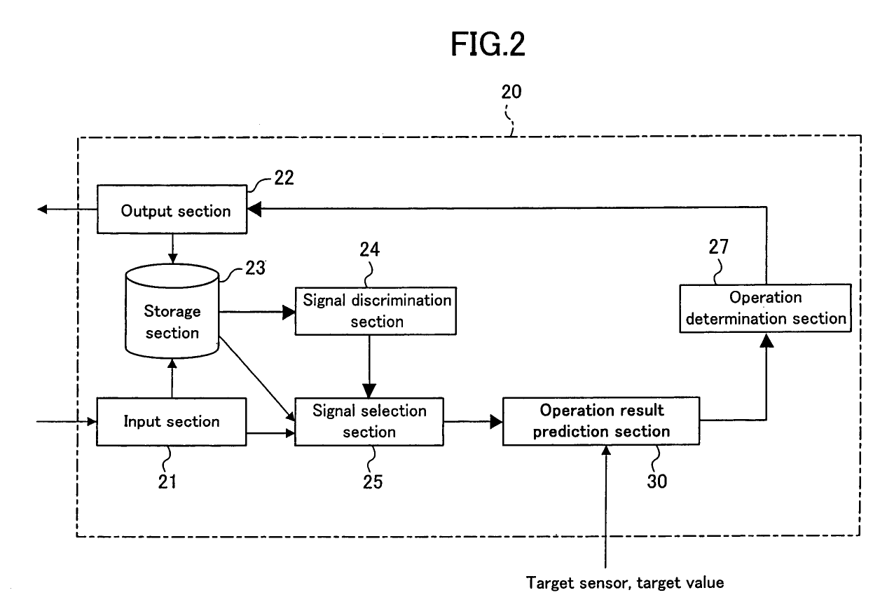

FIG. 2 is a block diagram showing an internal constitution of the agent 20 in FIG. 1. In FIG. 2, an input section 21 receives a signal from outside, wherein it receives output signals of sensors that the devices 11 to 17 such as the air conditioner 11 include in the example of the intelligent house 10 in FIG. 1. Also, the input section 21 receives signals indicative of operation contents of the devices 11 to 17. An output section 22 instructs each device 11 to 17 to perform an operation. For example, the output section 22 instructs the gas fan heater 15 to turn ON or OFF of combustion.

A storage section 23 stores, together with time data, various sensor signals detected in the input section 21 and operation contents that the output section 22 instructs or operation contents that the input section 21 receives. A signal discrimination section 24 serving as a sensor specification section analyzes relationships between sensor values and the operation contents stored in the storage section 23 and discriminates and lists up every sensor having intimate relation to the respective operations. A signal selection section 25 extracts only data relating to the specified sensor from the data read out from the storage section 23 on the basis of information received from the signal discrimination section 24.

An operation result prediction section 30 generates a model expressing a relationship between an operation and a change in sensor value, selects a candidate of operation for attaining a target state on the basis of the generated model, and evaluates a result of the operation. Upon receipt of an output from the operation result prediction section 30, an operation determination section 27 determines an operation for bringing the current state close to the target state and transmits contents of the determined operation to the output section 22.

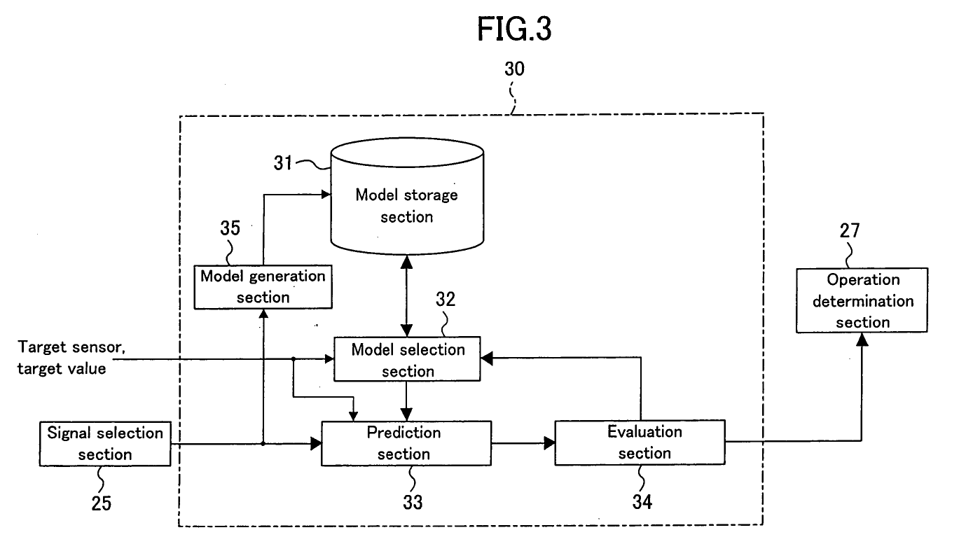

FIG. 3 is a block diagram showing an internal constitution of the operation result prediction section 30 in FIG. 2. In FIG. 3, a model generation section 35 generates a prediction model with the use of data selected in the signal selection section 25, and stores it into a model storage section 31. A model selection section 32 receives the name of a target sensor indicating the target state and a target value of its output, selects a prediction model including the target sensor from the model storage section 31, and transmits it to a prediction section 33. A plurality of models may be selected. The prediction section 33 performs prediction based on the model selected in the model selection section 32 and retrieves an operation candidate which can allow the sensor output to be the target value. An evaluation section 34 evaluates each operation candidate.

A device control method according to the present embodiment will be described. Herein, the agent 20 shown in FIG. 2 and FIG. 3 executes the method.

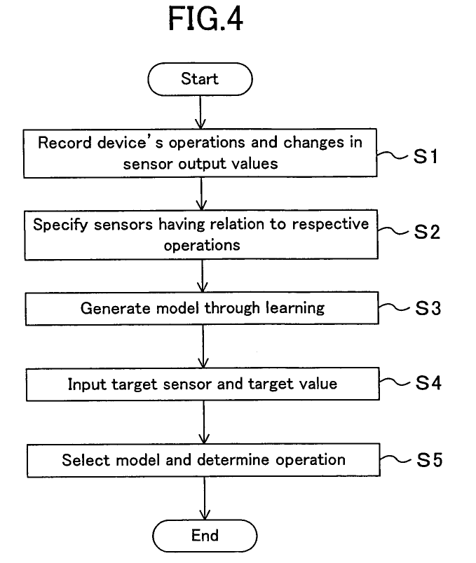

FIG. 4 is a flowchart showing an overall flow of the device control method according to the present embodiment. In a step S1 first, the agent 20 records to the storage section 23 operations of the plurality of devices 11 to 17 together with changes in sensor output values in the respective operations. In a brief time since the system starts operating, time for data acquisition is necessary because kinds of sensor signals having relation to the devices' operations are not known. When it is judged that sufficient data is acquired in the storage section 23, in a step S2, the signal discrimination section 24 specifies sensors having relation to the respective operations of the devices 11 to 17, that is, sensors of which output values are influenced.

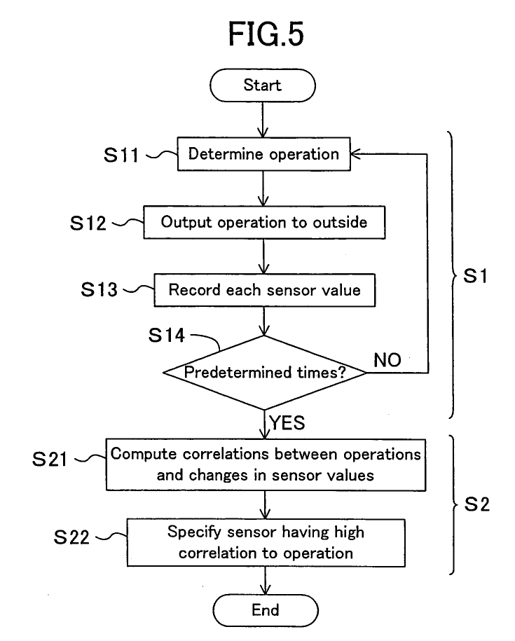

FIG. 5 is a flowchart showing one example of details of the step S1 and the step S2. In FIG. 5, steps S11 to S114 correspond to the step S1 and steps S21 to S23 correspond to the step S2.

First, an operation of a device is determined (S11), and the determined operation is output to the outside (living environment herein) (S12). These steps are executed in the case where a user manipulates the device or, as well, in the case where the agent 20 determines an operation and issues an operation instruction through the output section 22 so that the instructed device performs the determination operation. Particularly, the agent 20 has no appropriate operation determination method at the beginning, and therefore, device's operation is determined through user's manipulation in many cases.

Then, the agent 20 collects a subsequent change in output value of each sensor through the input section 21 and stores it and the operation contents instructed through the output section 22 into the storage section 23 together with time information. In the case where the user manipulates a device, operation contents thereof are received from the device through the input section 21 and are stored together with each change in output value of the sensors into the storage section 23 (S13).

The steps S11 to S13 are executed repeatedly (S14) until data expressing relationships between the devices' operations and the corresponding changes in sensor output values is accumulated by a predetermined times. When it is stored by the predetermined times, the routine proceeds to the next step S21. It is noted that the routine may proceeds to the next step S21 when a predetermined time period elapses, when a user instructs to do so, or the like, for example, other than when the data accumulation is performed by the predetermined times.

In the step S21, the signal discrimination section 24 computes correlations between the operations and the corresponding changes in sensor output values with the use of the data stored in the storage section 23. Then in the step S22, sensors having higher correlations with the respective operations are specified by, for example, threshold value processing from the result of correlation computation in the step S21. The signal discrimination section 24 provides information relating to the specified sensor pairs to the signal selection section 25.

Sensors having relation to the respective operation may be specified by a method other than that employing correlation computation, for example, by a method in which the neural network learns the operations and the changes in sensor output values and judgment is performed on the basis of magnitude of a joint load after learning such that a sensor having, for example, a small joint load value is judged to have no relation to the corresponding operation.

Referring back to FIG. 4, in a next step S3, a prediction model expressing a relationship between an operation and a sensor specified to have a relationship with the operation in the step S2 is generated through learning. The model employed herein is capable of expressing how sensor values change by a given operation of a given device. For example, an IF-THEN rule, a neural network, clustering, or the like may be employed.

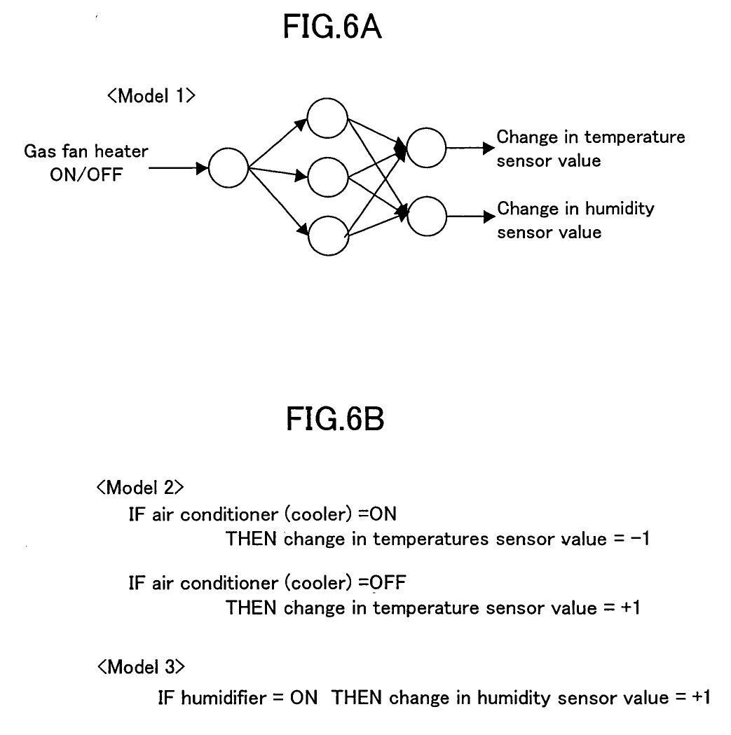

FIG. 6A is an example of a model description using a neural network, wherein changes in output values of the temperature sensor and the humidity sensor in response to the operation of the gas fan heater are modeled. When ON/OFF operations of the gas fan heater are made correspondence with inputs of “1” and “0,” respectively and each amount of changes per unit time in output values of the temperature sensor and the humidity sensor is used as an output, a one-input/two-output neural network is necessary as shown in FIG. 6A. Herein, the range of the output values is set between, for example, “−1” and “+1” in order to indicate degrees of changes in temperature sensor value and the humidity sensor value.

FIG. 6B is an example of a model description employing an IF-THEN rule, wherein a change in output value of the temperature sensor and a change in output value of the humidity sensor in response to the operation of the air conditioner are modeled.

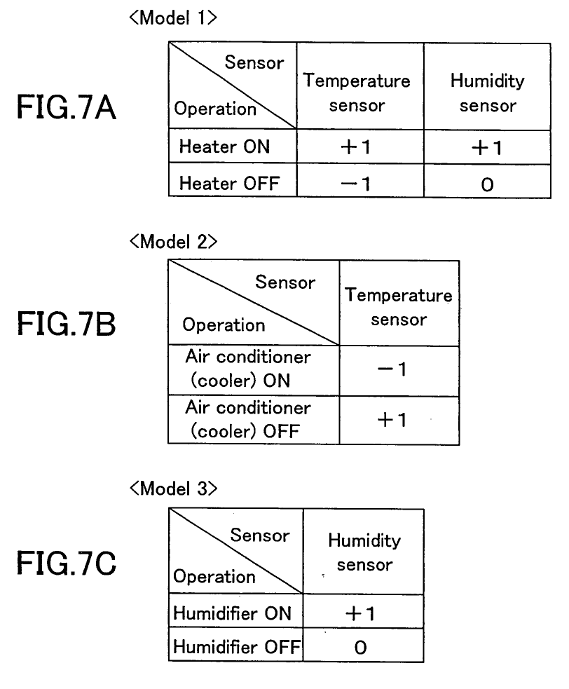

FIG. 7 schematically indicates data for leaning the models in FIG. 6. Wherein, FIG. 7A indicates data for learning the model 1 in FIG. 6A, and FIG. 7B and FIG. 7C indicate data for learning the models 2 and 3 in FIG. 6B, respectively.

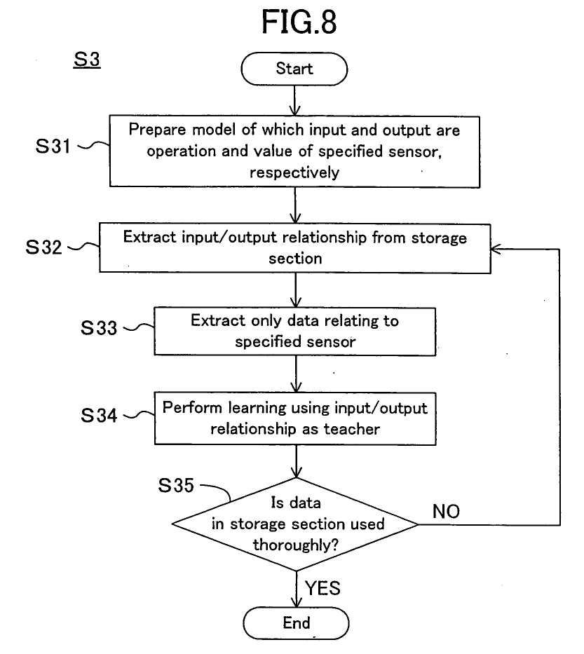

FIG. 8 is a flowchart showing one example of details of the step S3. First, the model generation section 35 in the operation result prediction section 30 prepares a model (S31). Herein, an unlearned model which inputs an operation and outputs an output value of a specified sensor is generated. The model expresses how a sensor value would change in response to a given operation, and is called a forward model.

Then, the signal selection section 25 reads out input/output relationship data, for example, one pair by one pair from the storage section 23 (S23). The input/output relationship data means an operation of a device at a given time and a change in output value of each sensor in response to the operation, and includes all the sensor signals that the system has at reading. After reading, the signal selection section 25 extracts only data relating to the sensor specified in the step S2 from the input/output relationship data on the basis of the information received from the signal discrimination section 24 (S33). Thus, teaching data for learning the model prepared in the step S31 is prepared.

The model generation section 35 receives the teaching data from the signal selection section 25 and performs leaning using the teaching data (S34). The steps S32 to S34 are executed repeatedly (S35) until the input/output relationship data stored in the storage section 23 is read out thoroughly. As a result, models expressing the relationships between the operations and the sensor values having relation thereto are generated.

It is noted that the forward model which inputs an operation and outputs a sensor value is used herein but a generally-called backward model which inputs a sensor value and outputs an operation can be learned. In a case using the forward model, a change in sensor value is predicted with various operations input as candidates and one, of which output sensor value is close to a target value, is determined as an operation. In contrast, in a case using the backward model, when a target sensor value is input, a desirable operation is output. In general, learning of the backward model would be difficult if input and output would not fall in one-to-one correspondence, and therefore, the forward model is preferable in view of wide applicable range.

Referring back to FIG. 4, in a step S4, an indication about a target sensor that defines a target state and a target value of an output thereof are received from outside. The target sensor and the target value herein may be determined according to user's request or determined by system's autonomous judgment through observation of a user's state. In a step S5, a model including the target sensor is selected from the models generated in the step S3, and an operation which allows an output of the target sensor to be the target value is determined on the basis of the selected model.

Herein, a state where the user who dwells in the intelligent house 10 can spend time comfortably is set as the target state. For example, a human thinks that he/she feels comfortable when room temperature and humidity are within given ranges. Accordingly, the temperature sensor and the humidity sensor are set as the target sensors and ideal temperature and humidity ranges for the user who dwells there are set to the target values to be output from the temperature sensor and the humidity sensor.

In general, it is said that ideal temperature and humidity range between 15° C. and 20° C. and between 40% and 60%, respectively. As to temperature, temperatures over the range cause a human to feel hot and temperatures below the range cause a human to feel cold. As to humidity, excessively low humidity invites multiplication of influenza virus while excessively high humidity invites generation of fungi and tick. Such an aspect relating to dweller's health may be taken into consideration, besides the aspect of the comfortableness. Excessively high humidity is liable to cause condensation, as well.

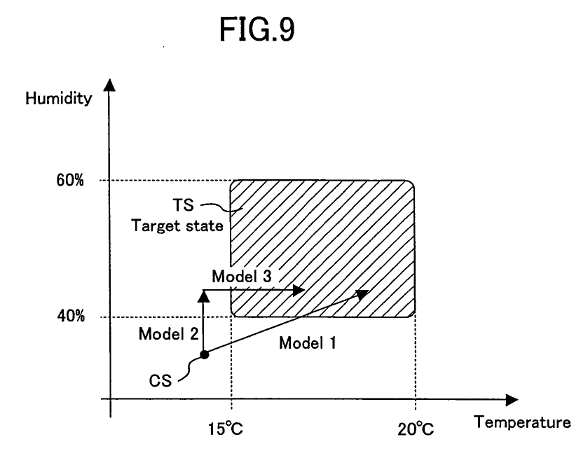

FIG. 9 is a schematic graph showing the target state in the case where the indoor comfortableness as described above is taken into consideration. In the graph of which axis of abscissas indicates temperature and axis of ordinates indicates humidity, the hatched area TS indicates a range where the user feels comfortable, that is, the target state. In FIG. 9, the ranges of temperature between 15° C. and 20° C. and of humidity between 40% and 60% are set as the target state TS. To change a current state CS to the target state TS is a purpose of device control. It is noted that the range of the target state TS may be set appropriately according to preferences of each user's home, time zones, seasons, and the like.

For example, in the case where a room state at return from out in winter is at a coordinate point CS, both the temperature and the humidity must be increased for changing the room state to the target state TS. However, the system includes a plurality of heating means and humidifying means, and therefore, an appropriate device must be selected from them and be controlled.

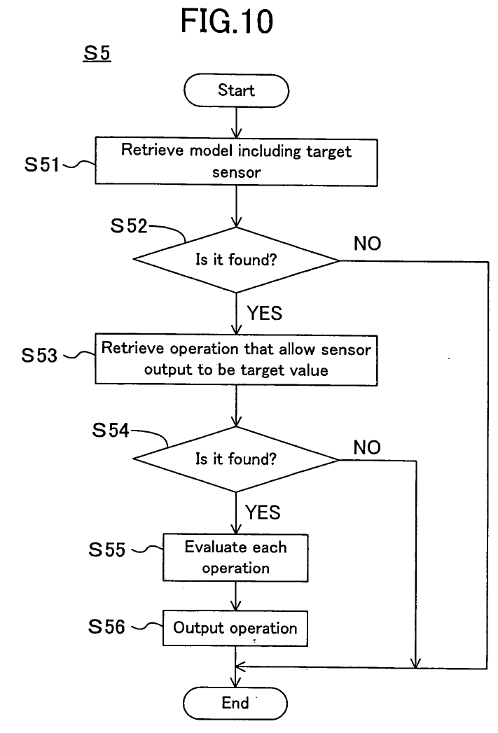

FIG. 10 is a flowchart showing one example of details of the step S5. First, the model selection section 32 retrieves a model including the target sensor from a plurality of models stored in the model storage section 31 (S51). When such a model is not found, the processing terminates (S52). Herein, suppose that three models are found.

Model 1: the operation of the gas fan heater 15 and the temperature sensor and the humidity sensor

Model 2: the heating operation of the air conditioner 15 and the temperature sensor

Model 3: the operation of the humidifier 16 and the humidity sensor

Next, the prediction section 33 retrieves an operation that allows a sensor output to be the target value on the basis of the model selected by the model selection section 32 (S53). For example, operation candidates capable of being performed are input to the selected model, and an operation candidate of which output to be obtained agrees with the target value or is close to the target value is retrieved. When such a operation is not found, the processing terminates (S54).

Suppose herein that examination of each of the three models 1 to 3 finds that the temperature and the humidity fall in the respective ranges of target values when using the model 1. Also, suppose that it is found that both the temperature and the humidity can be brought into the respective target ranges when using the models 2 and 3 in combination though only the temperature can be controlled when using the model 2 and only the humidity can be controlled when using the model 3. As a result, the following two candidates are sent to the evaluation section 34.

Candidate 1: the ON operation of the gas fan heater (model 1)

Candidate 2: the heating ON operation of the air conditioner (model 2) and the ON operation of the humidifier (model 3)

Next, the evaluation section 34 evaluates each operation candidate, and the operation determination section 27 determines an operation to be actually executed from the evaluation result (S55). Herein, each operation candidate is evaluated in view of energy conserving cost. In detail, the evaluation section 34 calculates an energy cost of each operation candidate, and the operation determination section 27 selects an operation candidate of which energy const is the lowest.

Specifically, comparison is performed between a cost calculated from gas input rating and a power consumption of the gas fan heater 15 in the candidate 1 and a cost calculated from a power consumption of the air conditioner 11 and a power consumption of the humidifier 16 in the candidate 2. When supposing that the candidate 1 involves an energy cost lower than the candidate 2 herein, the operation of the candidate 1, that is, the ON operation of the gas fan heater 15 is determined as the operation to be performed actually. The operation determination section 27 instructs the outside through the output section 22 to perform contents of the determined operation (S56). Herein, the final control target is the ON operation of the gas fan heater 15, and therefore, a control signal for turning ON is output to the gas fan heater 15.

As described above, in the present embodiment, each operation of the devices 11 to 17 is recorded in the storage section 23 together with every change in sensor output value at the operation, and a sensor of which output value is influenced by the operation is specified from the data recorded in the storage section 23. Then, models expressing the relationships between the operations and the specified sensors are generated through learning. Whereby, the prediction models are reduced in size, leaning ease is increased, and accuracy of the prediction models is increased even in a large-scale system. Hence, further appropriate operation can be determined.

The present embodiment describes the case where the agent 20 performs control of each device in the intelligent house 10. However, a device other than the agent 20 in the intelligent house 10 may control an operation of its own or of the other devices in the same manner as in the present embodiment by referencing sensor information of the other devices. In other words, the agent is not necessarily independent and the function of the agent may be realized in any of the devices connected to the network.

The gas fan heater 15 will be described as an example. In the case where the gas fan heater 15 operates solely, a relationship between an output thereof and the sensor value is comparatively simple and temperature increase/decrease depends on an ON/OFF operation of a combustion switch. This is within a range that the designer can design in advance.

While, if the gas fan heater 15 could obtain the sensor signals from the other devices in the intelligent house 10, it could be recognized that the combustion operation of the gas fan heater 15 changes output values of multiple sensors. For example, if an increase in output value of the humidity sensor could be recognized, it can be found that the gas fan heater 15 could control the humidity in addition to the original purpose of temperature control. When a prediction model expressing a relationship between the operation of the gas fan heater 15 and a change in humidity sensor value is generated, the combustion ON operation of the gas fan heater 15 is added as an alternative with respect to a request for “increasing the humidity.” Thus, in the configuration in which devices are connected with each other through the network, a prediction model which was not presupposed at the initial stage can be generated, enabling provision of further flexible response to user's request.

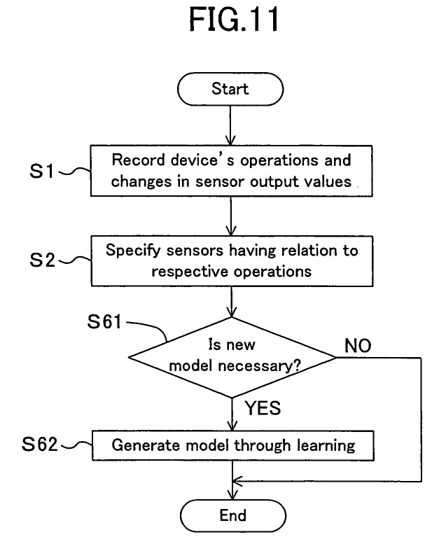

Further, when the configuration of a device and sensors in the system is changed, such as a case when a new sensor or device is added, a case where an already connected device or sensor is taken away or replaced, or the like, an operation as shown in FIG. 11 can be executed. Specifically, after execution of the same processing as the above described steps S1 and S2, whether or not a new model is necessary is judged from the processing result in the step S2 (S61). This judgment can be performed by confirming whether or not there are any sensors of which output values are influenced by a given operation besides the already specified sensor. When judged necessary, a new model is generated through learning (S62). This eliminates the need to perform model generation when the already generated prediction model suffices at change in configuration of the device and sensors, reducing the processing amount.

Further, the modeling processing as shown in FIG. 11 is preferably performed when external environment change is great, besides when a device or a sensor is added. For example, a change in external environment which influences the temperature and the humidity significantly may include change in temperature and humidity caused due to difference in season, variations in temperature and humidity within a day, and the like. For example, changes in temperature and humidity at window opening could be opposite depending on the season, and the brightness of the outside may influence a relationship between lighting equipment and a luminous sensor to a large extent.

Some of such changes can be coped by incorporating an outdoor temperature sensor or the like into the network. A model change and the like are effective for the large change depending on the season. The model change can be performed in such a manner that a part for storing a plurality of model sets is prepared and the model sets are exchanged according to the season. This enables coping without re-learning from the beginning.

### Embodiment 2

One of significant features in Embodiment 2 of the present invention lies in that in the step S5 in the flow of FIG. 4, a future change in output value of the target sensor is taken into consideration in the operation determination based on the prediction model obtained through learning.

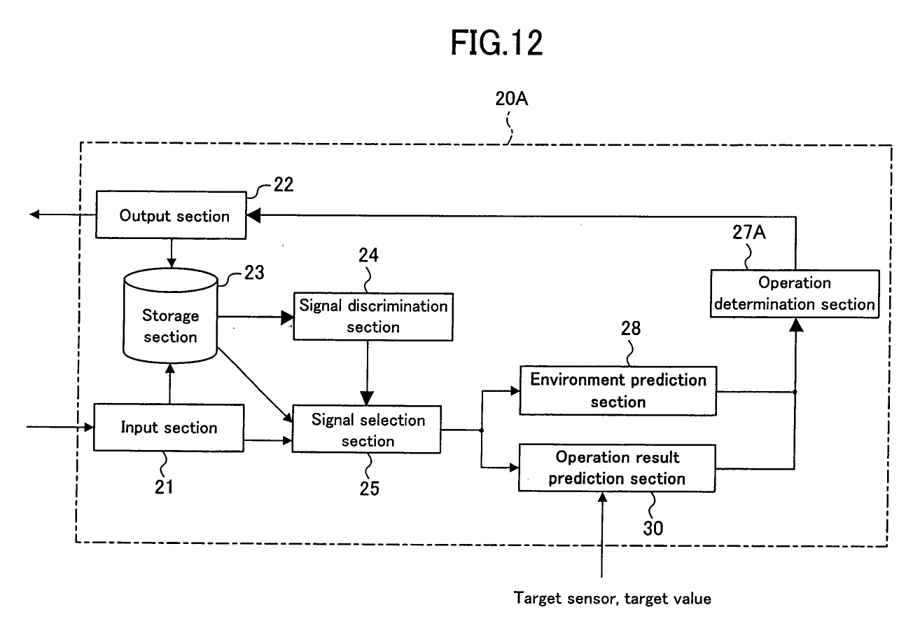

FIG. 12 shows a constitution of an agent 20A according to the present embodiment. In FIG. 12, the same reference numerals are assigned to constitutional elements common to those in FIG. 1, and the detailed description thereof is omitted here. Difference in constitution from FIG. 1 is that an environment prediction section 28 is provided for predicting a future change in output value of the target sensor which is caused due to a factor other than the corresponding operation of the device.

In the actual system, there is a case where prediction of an external factor is necessary for determining an operation. For example, in the example of the aforementioned intelligent house 10, the output value of the temperature sensor is changed by operating the gas fan heater 15. While, it receives an influence of external factors other than that, specifically, for example, outdoor temperature, an operation of another device such as the air conditioner, and the like. If a future change in sensor output value caused due to these external factors could be predicted, further appropriate operation could be determined.

For example, in the case where a temperature increase is the purpose, when the environment prediction section 28 predicts that the room temperature would increase on the basis of recognition that the cooker 13 is currently in use, control of withdrawing performance of the operation determination section 27A could be performed even if the operation result prediction section 30 determines the combustion operation of the gas fan heater 15.

As described above, provision of the environment prediction section 28 enables a future change in output value of the target sensor to be taken into consideration, resulting in further suitable operation determination.

### Embodiment 3

The above embodiments reference an example of utilization in the intelligent house but the present invention is applicable to other use, for example, to generation of motion models of a home use robot.

A home use robot generally includes, as input sensors, a visual sensor for video input, an auditory sensor for speech input, a tactile sensor for detecting user's direct touch to the robot, a ultrasonic sensor for detecting a distance or an obstacle, encoders for detecting angles of joints, a sensor for detecting gravity movement, and the like. Further, it includes, as actuators for motion, a leg or a tire for transfer, a hand for moving an object, a head portion for expressing a viewing direction, nodding, and the like, a motor or a light for generating facial expressions, a speaker for speaking to the user, and the like. Particularly, a home use robot having a multifunction incorporates several tens of sensors for input and several tens of actuators for output, the numbers of which will be expected to be increased more and more in the future.

In such a home use robot, when prediction models are learned with input/output fixed as in the conventional case, leaning is not necessarily converged.

Under the circumstances, it is desirable for control of the home use robot to select only sensor signals that influence respective outputs (motions by actuators) and generate prediction models with the use of the selected sensor signals.

For example, when a motion is instructed to a right hand actuator, a signal of an encoder at right hand changes in response to the motion while sensor signals from encoders at the left hand and the leg section might not change and singles of the auditory sensor and the ultrasonic sensor might not change, as well. In view of this, a model for the motion of the right hand actuator is generated using only the encoder at the right hand from the relationships between past operations and changes in sensor output values.

The intelligible example is referenced herein for the sake of simplicity, but it can be said that there is infinite causality between actuators and sensors of the robot, such as between an operation of advancing and the visual sensor, between a synthetic speech output from the speaker and sensing of user's reaction, and the like. In the present embodiment, the causality is extracted from the relationships between the past operations and changes in sensor output values, so that compact and accurate prediction models can be generated through learning, attaining further appropriate operation determination.

(Simulation)

The inventors carried out simulation for specifying a sensor having relation to device's operation on the assumption of the intelligent house as shown in FIG. 1. In the intelligent house, devices and sensors are connected one another through a network, and accordingly, each operation of the devices and each operation state of the sensors can be grasped. Various operations of the devices exert various influences on sensor values. Which device exerts an influence on which sensor is specified.

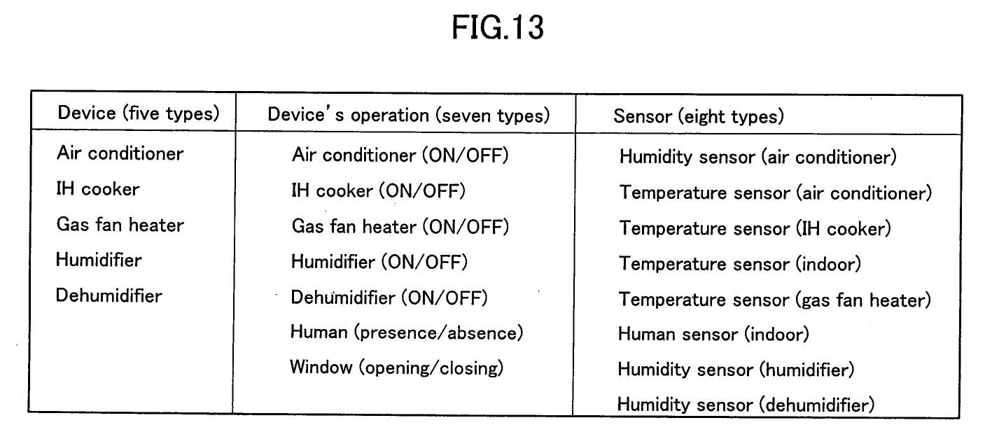

FIG. 13 is a list indicating devices, device's operations, and sensors which were considered in the present simulation. As shown in FIG. 13, five kinds of devices of an air conditioner (cooler), an IH cooker, a gas fan heater, a humidifier, and a dehumidifier were considered as the devices relating to the temperature and the humidity in the intelligent house. Seven kinds of operations of ON/OFF operations of the respective devices and operations for state changes, that is, detection of presence/absence of a human and opening/closing of a window were considered as the devices' operations. Eight kinds of sensors were considered which might be incorporated in the respective devices.

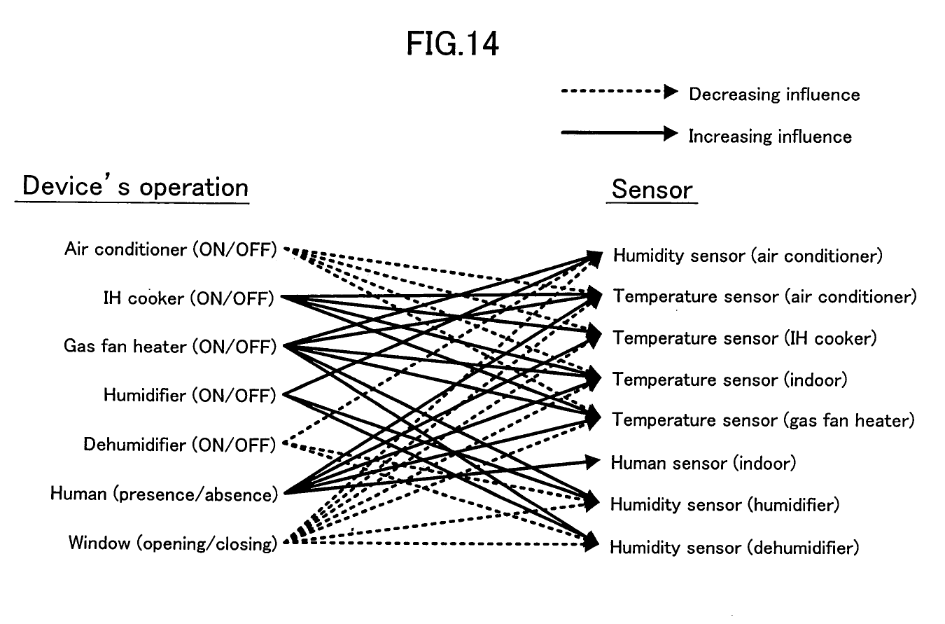

FIG. 14 is a diagram showing the relationships between the devices' operations and the sensors which are set in the present simulation. In FIG. 14, two kinds of arrows are drawn from the device operation site towards the sensor site, wherein the arrows in solid lines indicate influences showing increasing inclination and the arrows in dotted lines indicate influences showing decreasing inclination. There are a plurality of sensors for measuring the humidity or a plurality of sensors for measuring the temperature, and accordingly, the relationships between the devices' operations and the sensors overlap. Wherein, a learning subject is as to whether the sensor values show increasing inclination or decreasing inclination, rather than the sensor values themselves. This simplifies the models, but the sensor values themselves may be learned.

The purpose of the simulation is to extract each relationship between the devices' operations and the changes in sensor values under the aforementioned set conditions.

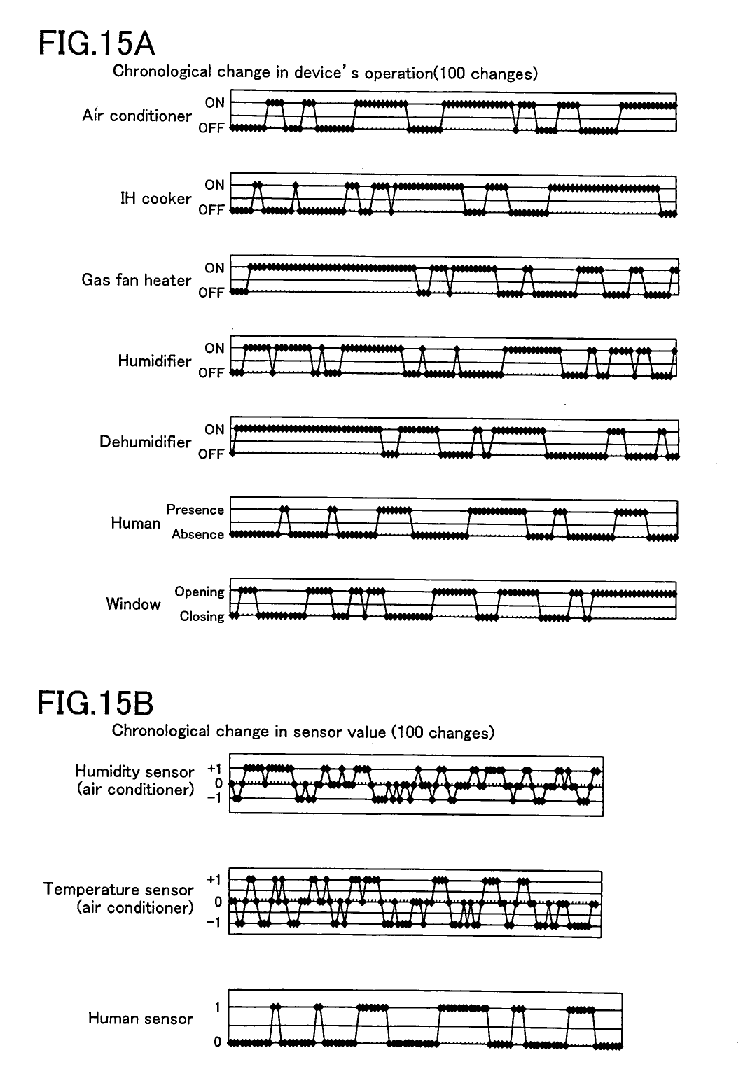

FIG. 15 presents graphs showing results obtained by simulating the relationships between the devices' operations and the sensor values under the conditions set in FIG. 13 and FIG. 14. FIG. 15A shows chronological changes in the devices' operations. Herein, in order to reproduce states where the devices' operations are executed in various combinations by various device manipulations, random ON/OFF manipulation of a device selected at random was executed 100 times repeatedly. FIG. 15B shows chronological changes in sensor values in response to the chronological changes in the devices' operations in FIG. 15A. Wherein, only the humidity sensor of the air conditioner, the temperature sensor of the air conditioner, and the human sensor are indicated out of the eight sensors. As to the humidity sensor and the temperature sensor, 0 means no change in sensor value, +1 means an increase in sensor value, and −1 means a decrease in sensor value. As to the human sensor, 1 means the presence of a human and 0 means the absence of a human.

As understood from FIG. 15A and FIG. 15B, the sensor values change correspondingly to the chronological changes of the devices' operations. The graphs in FIG. 15 were obtained when random manipulation series was given on the basis of the relationship indicated in FIG. 14. In the actual intelligent house, also, the respective sensor values might increase or decrease according to the operation states of a plurality of devices. Accordingly, it makes no difference to consider that chronological data similar to that in FIG. 15 can be obtained in the control system of the intelligent house.

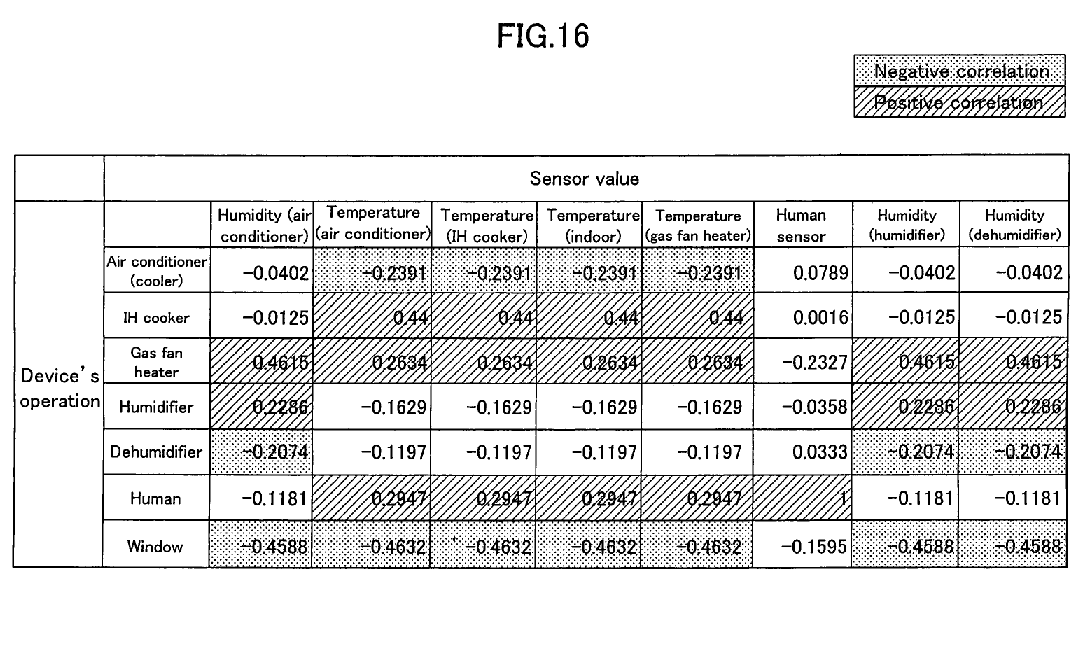

FIG. 16 indicates results of correlations between the respective devices' operations and the sensor values from the data indicated in FIG. 15. In FIG. 16, the results are grouped into combinations falling in positive correlations, combinations falling in negative correlations, and combinations falling in no correlation, with a threshold value set to ±0.2. From FIG. 16, a relationship can be found which, for example, the ON operation of the air conditioner decreases the values of the temperature sensor of the air conditioner, the temperature sensor of the IH cooker, the room temperature sensor, and the temperature sensor of the gas fan heater. In this case, extraction and learning of only the four sensors leads to description of a relationship model. Further, it is found that the ON operation of the humidifier increases the values of the humidity sensor of the air conditioner, the humidity sensor of the humidifier, and the humidity sensor of the dehumidifier. Therefore, only the three sensors are extracted for modeling, similarly to the case of the air conditioner.

As described above, after the sensors having relation to the respective devices are specified, various schemes for expressing the relationships can be employed, such as the neural network in FIG. 6A, the IF-THEN rule in FIG. 6B, the table in FIG. 7, and the like.

Computation time periods were compared between a case of executing specification of sensors having relation to the respective devices' operations and a case of executing no specification thereof. In detail, comparison in computation time periods were carried out between the case where the relationships between the devices' operations and the sensors are obtained and are learned by the correlation computation shown in FIG. 16 and the case where the relationships therebetween are learned directly from the data shown in FIG. 15 with no correlation computation performed. A neural network in a three-layer hierarchy was used, a back propagation method was employed as a learning method, and 50000-time learning or 10⁻⁵ or less mean square error was set as a condition of computation end.

The comparison resulted in that 372-time leaning lead to learning end in the case with correlation computation while 50000-time computation decreased error insufficiently and lead to no learning end in the case with no correlation computation.

The results indicate that: sufficient leaning is difficult even with only seven or eight devices or sensors in the case where the relationships between the devices and the sensors are learned directly from the chronological data with no sensors having relation to the devices' operations specified. An increase in the number of devices or sensors leads to substantial impossibility of learning, of course. Though the designers have coped with difficulty in this learning conventionally by providing the relationships between the devices' operations and the sensors in the form of a rule or the like in advance, such countermeasures cannot cope with addition of a device or a change in configuration of a device. In contrast, when learning is performed after specification of the sensors having relation to the devices' operations as in the present invention, the learning becomes easy and simple expressions as in FIG. 6 and FIG. 7 can be employed. Further, addition of a device and a change in configuration of a device can be supported.

The present simulation used the temperature sensors and the humidity sensors which the respective devices include and which receive influence of the devices' operations uniformly. However, the places where the sensors are installed are different from each other in practice. For example, the temperature sensor of the air conditioner is installed in the vicinity of the ceiling, the temperature sensor of the gas fan heater is installed in the vicinity of the floor, the temperature sensor of the IH cooker is installed in the kitchen, and so on. As a matter of course, influences of the devices on the sensors are not uniform, and the sensors might receive the influences with different strengths. In the present embodiment, a relationship which cannot be presupposed in advance can be found even in such a situation, and therefore, efficient model learning might be enabled.

For example, in an intelligent house in which a device group having no relation to temperature and humidity are also connected, there is a possibility of detecting a relationship that the sensor value of a temperature sensor increases when a video device such as a plasma display (PDP) is turned ON. In this case, when the PDP is turned ON, for example, the room temperature can be maintained to be a desired temperature by controlling another device's operation which influences the temperature, for example, by decreasing an output of the gas fan heater.

Furthermore, there is a case, for example, where an odor sensor for detecting raw garbage is incorporated in a garbage disposal or the like, of which introduction into home has been progressing in recent years. Connection of the odor sensor to the network in the intelligent house offers a possibility that a relationship that the sensor value of the odor sensor increases when another device, for example, an oil fan heater is turned OFF is detected and learned as a model. From the model, it is inferred that the value of the odor sensor exceeds a predetermined range at the OFF operation of the oil fan heater. In this case, accordingly, a model of a window opening operation and a decrease in the odor sensor value, which has been already acquired, is activated and control of the window opening is realized automatically.

Moreover, there may be the case where a pollen sensor, which is a novel sensor, is added to the network when an air cleaner is added to the network in the intelligent house, for example. Relationships between the operations of the already installed devices and the pollen sensor can be detected newly upon addition of the pollen sensor. Conventionally, for example, the control of the widow opening is executed in order to bring the value of the odor sensor to be in a predetermined range. While in this case, the relationship that the value of the pollen sensor increases upon window opening is detected newly, and accordingly, the control of turning ON of the air cleaner is selected instead.

In contrast to the present invention, the conventional method in which the rule is set in advance cannot detect a relationship that is difficult to presuppose in advance, such as the relationship between the PDP and the room temperature, and a novel relationship when a new kind of sensor that has not been presupposed in advance is added, such as the relationship between the OFF operation of the oil fan heater and the odor sensor of the garbage disposal.

In the network through which devices are connected, an additional device would be purchased or a novel device would be released. In other words, the configuration of the device group is considered to be changed to such an extent that presupposition is difficult at the time when the processing system of the network is set. In such cases, the method of autonomously finding and modeling the relationships between devices' operations and sensor values as in the present invention is considered much effective.

In the present invention, a prediction model can be generated autonomously by specifying only a necessary sensor according to each relationship between operations and sensor outputs with no input/output designed in advance, and therefore, the present invention is effective especially in a system having numerous inputs and outputs and a system of which configuration is changed frequently. Specifically, the present invention is effective in, for example, home device networks in intelligent houses, autonomous robots having numerous inputs and outputs, and the like. Also, the present invention is applicable into generation of motion models of actuators for sensor networks through which numerous sensors are connected.

What is claimed is:

1. In a system including at least one device and a plurality of sensors, a device control method for controlling the device, comprising:
a first step of recording an operation of the device into a storage section together with a change in output value of each of the sensors at the operation;
a second step of specifying at least one of sensors of which output value is influenced by the operation from data recorded in the storage section;
a third step of generating, through learning, a prediction model expressing a relationship between the operation and the sensor specified regarding the operation in the second step, from the data recorded in the storage section;
a fourth step of receiving an indication about a target sensor that defines a target state and a target value for an output of the target sensor; and
a fifth step of selecting a model including the target sensor from the prediction model generated in the third step and determining an operation that allows the output of the target sensor to be the target value on the basis of the selected model,
wherein when a configuration of the device and the sensors in the system are changed,
the first step and the second step are executed, and
whether or not a new prediction model is necessary is judged from a processing result in the second step, and
the new prediction model is generated through learning when the new model is judged necessary.

2. The device control method of claim 1,
wherein sensor specification in the second step is executed by obtaining a correlation between the operation and the change in output value of each of the sensor.

3. The device control method of claim 1,
wherein sensor specification in the second step is executed using a neural network.

4. The device control method of claim 1,
wherein in the fifth step, operation determination is executed with a future change in output value of the target sensor taken into consideration.

5. In a system including at least one device and a plurality of sensors, a device control system for controlling the device, comprising:
a storage section for storing an operation of the device together with a change in output value of each of the sensors at the operation;
a sensor specifying section for specifying at least one of sensors of which output value is influenced by the operation from data recorded in the storage section;
a model generation section for generating, through leaning, a prediction model expressing a relationship between the operation and the sensor specified regarding the operation in the sensor specifying section, from the data recorded in the storage section;
a model selection section for receiving an indication about a target sensor that defines a target state and a target value for an output of the target sensor and selecting a model including the target sensor from the prediction model generated by the model generation section; and
an operation determination section for determining an operation which allows an output of the target sensor to be the target value on the basis of the model selected by the model selection section,
wherein when a configuration of the device and the sensors in the system are changed,
the storage section performs storage and the sensor specification section performs sensor specification, and
the model generation section judges whether or not a new prediction model is necessary from a performance result of the sensor specification section and generates the new prediction model through leaning when the new model is judged necessary.

6. The device control system of claim 5,
wherein any one of the at least one device includes the system.
